(19) United States
(12) Patent Application Publication
(10) Pub. No.: US 2019/0022919 A1
(43) Pub. Date: Jan. 24, 2019

(54) METHOD AND APPARATUS FOR PRODUCING A LAMINATE FROM ONE OR MORE LAYERS OF MATERIAL

(71) Applicant: SABIC Global Technologies B.V., Bergen op Zoom (NL)

(72) Inventors: Roel Verlaek, Elsloo (NL); Theofanis Theofanous, Sugar Land, TX (US); Guillaume Ratouit, Elsloo (NL); Nikhil Verghese, Geleen (NL)

(21) Appl. No.: 16/081,740

(22) PCT Filed: Mar. 1, 2017
(86) PCT No.: PCT/IB2017/051203

§ 371 Date: Aug. 31, 2018

Related U.S. Application Data
(60) Provisional application No. 62/301,961, filed on Mar. 1, 2016.
(60) Provisional application No. 62/441,820, filed on Jan. 3, 2017.

(51) Int. Cl. B29C 53/58; B29C 53/70; B29C 53/80; B29C 70/32

(52) U.S. Cl. CPC B29C 53/582; B29C 53/70; B29C 53/8058; B29K 2105/105; B29C 70/32; B29C 2793/0036; B29C 2793/009; B29C 53/8083

(57) ABSTRACT

The present invention concerns a method and apparatus (14a) for winding a section of each of one or more layers of material (18a) around a mandrel (30) and about a longitudinal axis of the mandrel (30), wherein each layer of material (18a) includes fibers and the winding is performed such that, for the wound section of each layer of material (18a), each of a majority of the fibers is angularly disposed relative to the longitudinal axis of the mandrel (30), and: (1) disposing a tape (82) over the layer(s) of material (18a) such that at least a portion of the tape (82) overlies at least a portion of the wound section of each layer of material (18a) and a long dimension of the portion of the tape (82) is substantially parallel to the longitudinal axis of the mandrel (30); and/or (2) spot-joining adjacent sections of the wound section(s) together.

### CROSS-REFERENCE TO RELATED APPLICATIONS

This application claims priority to U.S. Provisional Patent Application Ser. No. 62/301,961 filed Mar. 1, 2016 and U.S. Provisional Patent Application Ser. No. 62/441,820 filed Jan. 3, 2017. The entire contents of each of the above-referenced disclosures are specifically incorporated herein by reference without disclaimer.

### BACKGROUND

### 1. Field of Invention

The present invention relates generally to composite materials, and more specifically, but not by way of limitation, to methods and systems for producing laminate, such as, for example, an angle-ply laminate, from one or more layers of material, such as, for example, one or more unidirectional fiber tapes.

### 2. Description of Related Art

When manufacturing a part, a laminate can be placed on and/or within the part to provide additional strength and/or stiffness in certain areas, facilitating the part in meeting strength, stiffness, weight, and other requirements. For some parts, relatively complex laminates may be desirable, such as those that include one or more angle-ply laminae, each having fibers oriented relative to a long dimension of the lamina at one or more of a variety of angles.

In many instances, a lamina may comprise a composite tape. Perhaps due to manufacturing difficulties, only certain types of composite tapes may be readily available, such as, for example, those that include fibers aligned with a long dimension of the tape (e.g., unidirectional fiber tapes, 0/90 tapes, and/or the like). Thus, to achieve a relatively complex laminate using readily available composite tapes often requires costly machinery to accurately place sections of the tapes in the desired orientations to produce the various angle-ply laminae.

Publication Numbers US 2010/0075126 and WO 2014/125268 each disclose methods and apparatuses for producing an angle-ply lamina by: (a) winding one or more composite tapes around a mandrel to form a tube; and (b) cutting the tube to produce the lamina. In these methods and apparatuses, the composite tape(s) are located relative to one another along the tube by continuously bonding the edges of the tape(s) to one another, which may be complex and/or cause imperfections, such as distortion of the tape(s), in the produced lamina. These methods and apparatuses may not adequately protect the composite tape(s) or produced lamina from damage (e.g., fraying, fiber dislocation, and/or the like) that may result during or after cutting of the tube.

### SUMMARY

Some embodiments of the present disclosure may facilitate locating layer(s) of material that are wound around a mandrel relative to one another along the mandrel, while mitigating distortions of the layer(s) of material, via including and/or being configured for: (1) disposing a tape over the layer(s) of material such that at least a portion of the tape overlies at least a portion of the wound section of each layer of material and, in some such embodiments, a long dimension of the portion of the tape is substantially parallel to a longitudinal axis of the mandrel; and/or (2) spot-joining adjacent (e.g., edge-to-edge and/or overlapping) sections or wraps of the wound section(s) together such that, in some such embodiments, at least two of the joined spots lie along a line that is substantially parallel to the longitudinal axis of the mandrel.

Some embodiments of the present disclosure may protect layer(s) of material that are wound around a mandrel from damage that might otherwise occur during or after slitting of the wound section(s) of the layer(s) of material to produce a laminate, via including and/or being configured for disposing a tape over the layer(s) of material such that at least a portion of the tape overlies at least a portion of the wound section of each layer of material and, in some such embodiments, a long dimension of the portion of the tape is substantially parallel to a longitudinal axis of the mandrel, and slitting the portion of the tape and the wound section(s) to produce the laminate.

The term “coupled” is defined as connected, although not necessarily directly, and not necessarily mechanically; two items that are “coupled” can be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the term “substantially” can be substituted with “within [a percentage] of” what is specified, where the percentage includes 0.1, 1, 5, and 10 percent.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus that “comprises,” “has,” or “includes” one or more elements possesses those one or more elements, but is not limited to possessing only those elements. Likewise, a method that “comprises,” “has,” or “includes” one or more steps possesses those one or more steps, but is not limited to possessing only those one or more steps.

The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or.

Any embodiment of any of the apparatuses, systems, and methods can consist of or consist essentially of—rather than comprise/include/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment can be applied to other embodiments, even though not described or illustrated, unless expressly prohibited by this disclosure or the nature of the embodiments.

Some details associated with the embodiments described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number can be used to indicate a similar feature or a feature with similar functionality, as can non-identical reference numbers.

FIG. 1 is a flow chart representative of some embodiments of the present methods.

FIGS. 2A and 2B are schematic views of a roll-to-roll process for producing an angle-ply laminate from a unidirectional fiber tape according to some embodiments of the present disclosure.

FIG. 3 is a cross-sectional end view of the mandrel shown in FIGS. 2A and 2B.

FIG. 4A is a schematic view of a process for producing an angle-ply laminate from two or more unidirectional fiber tapes according to some embodiments of the present disclosure.

FIG. 4B is a schematic view of a process for producing an angle-ply laminate from two or more unidirectional fiber tapes according to some embodiments of the present disclosure.

FIG. 5A depicts a front view of a roller, which may be suitable for use in some embodiments of the present disclosure.

FIG. 5B depicts a cross-sectional end view of a mandrel, which may be suitable for use in some embodiments of the present disclosure.

FIG. 6A is a schematic view of a unidirectional fiber tape, which may be suitable for use in some embodiments of the present disclosure.

FIG. 6B is a schematic view of a laminate, which may be produced from the unidirectional fiber tape of FIG. 6A using the process of FIGS. 2A and 2B.

FIG. 7 is a cross-sectional end view of a mandrel, which may be suitable for use in some embodiments of the present disclosure.

FIG. 8A depicts layers of material wound around a mandrel, each having been cut to define an end of the layer at 90° relative to a length of the layer.

FIG. 8B depicts layers of material wound around a mandrel, each having been cut to define an end of the layer that, when the layer is wound around the mandrel, is flush with the end of the mandrel.

FIGS. 9 and 10 are graphs of scrap rate vs. winding angle for various layers of material wound around mandrels of differing diameter.

FIG. 11 is a graph illustrating the width of a layer of material that is desirable when the layer is to be wound around a mandrel for various mandrel diameters and winding angles.

### DETAILED DESCRIPTION

As used in this disclosure, a “lamina” is a layer of material that is formed by introducing a matrix material into an arrangement of fibers, and “laminae” is the plural form of lamina. A “laminate” is a layer of material including one or more laminae, whether or not consolidated. As used herein, an “angle-ply” laminate is a laminate including at least one lamina in which substantially all of the fibers are angularly disposed relative to a long dimension of the laminate.

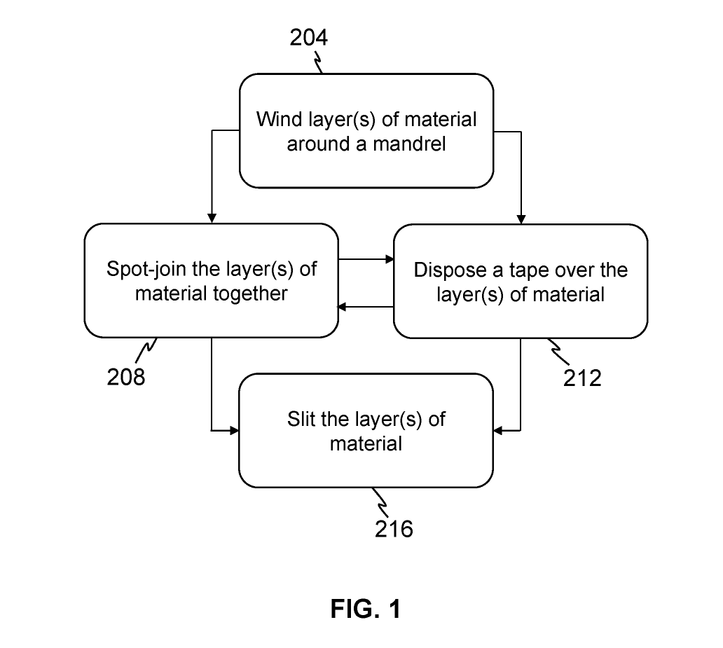

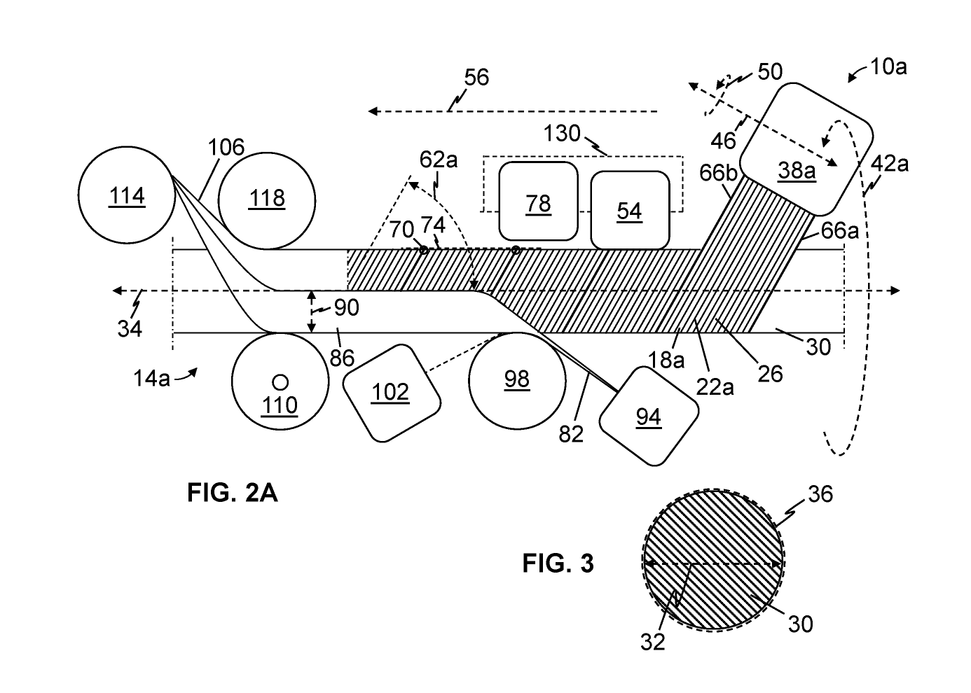

FIGS. 2A and 2B show one embodiment 10a of the present methods, as performed using one embodiment 14a of the present systems. Throughout this disclosure, system 14a is provided and discussed only by way of illustration, as the present methods, including method 10a, can be performed using any suitable system. Some embodiments of the present methods include winding a section (sometimes referred to as a wound section) of each of one or more layers of material (e.g., 18a, 18b, 18c, and/or the like) around a mandrel (e.g., 30) (e.g., step 204, FIG. 1). For example, method 10a includes winding a section of layer of material 18a around mandrel 30. Such a layer of material (e.g., 18a, 18b, 18c, and/or the like) can include fibers (e.g., 22a, 22b, 22c, and/or the like), such as, for example, carbon, glass, basalt, cloth, and/or the like fibers, which can be dispersed within a matrix material (e.g., 26) (e.g., the layer of material may comprise a laminate). For a layer of material (e.g., 18a, 18b, 18c, and/or the like) including fibers (e.g., 22a, 22b, 22c, and/or the like), such fibers can be oriented relative to one another within the layer of material in any suitable fashion, such as, for example, being aligned with or angularly disposed relative to one another, defining a layered and/or interwoven structure, and/or the like. For example, layer of material 18a is a laminate that includes fibers 22a dispersed within a (e.g., thermoplastic) matrix material 26, where substantially all of the fibers are substantially parallel to one another and a long dimension of the layer of material (e.g., layer of material 18a comprises a 0 degree unidirectional fiber tape). A layer of material (e.g., 18a, 18b, 18c, and/or the like) may not comprise fibers. A layer of material (e.g., 18a, 18b, 18c, and/or the like) may comprise a mesh, honeycomb, and/or the like structure.

Provided by way of example, a thermoplastic matrix material (e.g., 26) can comprise polyethyleneimine, polyetherimide, or a derivative thereof, polyethylene terephthalate, polycarbonate, polybutylene terephthalate, poly(1,4-cyclohexylidene cyclohexane-1,4-dicarboxylate), glycol-modified polycyclohexyl terephthalate, poly(phenylene oxide), polypropylene, polyethylene, polyvinyl chloride, polystyrene, polymethyl methacrylate, thermoplastic elastomer, terephthalic acid elastomer, poly(cyclohexanedimethylene terephthalate), polyethylene naphthalate, polyamide (e.g., PA6, PA66, and/or the like), polysulfone sulfonate, polyether ether ketone, polyether ketone ketone, acrylonitrile butyldiene styrene, polyphenylene sulfide, polycarbonate/polybutylene succinate, a co-polymer thereof, or a combination thereof.

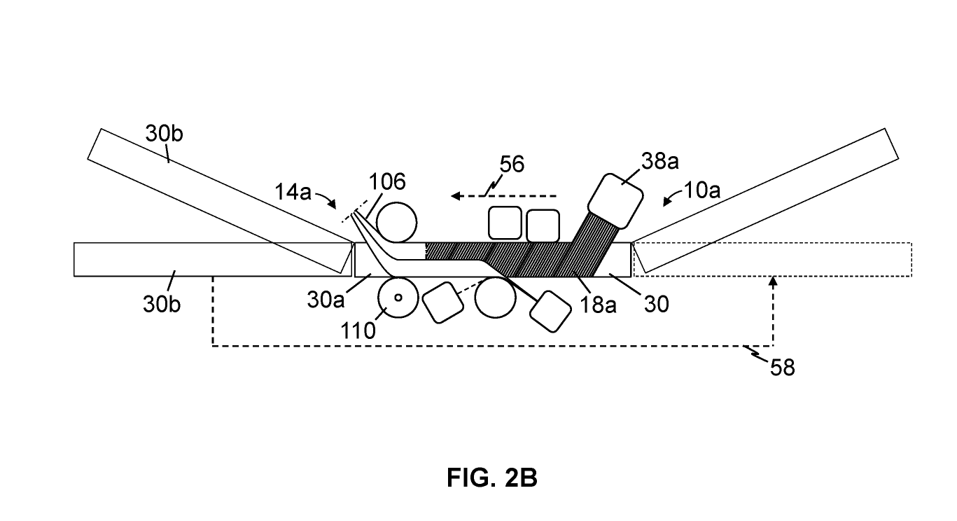

Mandrel 30 of system 14a has a longitudinal axis 34. Mandrel 30 has a cross-section, taken perpendicularly to longitudinal axis 34, that defines a circular outer perimeter 36 (FIG. 3). Outer perimeter 36 of mandrel 30 is constant along longitudinal axis 34, at least for a portion of the mandrel around which layer(s) of material (e.g., 18a) are intended to be wound (e.g., the mandrel, or portion thereof, is cylindrical). A mandrel (e.g., 30) can comprise any suitable shape, such as, for example, having an outer perimeter (e.g., 36) that is triangular, square, rectangular, otherwise polygonal, circular, elliptical, otherwise rounded, and/or the like, and the outer perimeter can vary in size and/or shape along a longitudinal axis (e.g., 34) of the mandrel (e.g., the mandrel can be tapered and/or twisted along the longitudinal axis). A mandrel (e.g., 30) can have any suitable dimensions, such as, for example, a maximum transverse dimension (e.g., 32) (e.g., a diameter) that is greater than or equal to any one of, or between any two of: 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, or more millimeters (mm).

A mandrel (e.g., 30) can be configured to facilitate retention of wound section(s) of layer(s) of material (e.g., 18a, 18b, 18c, and/or the like) relative to the mandrel. For example, a mandrel (e.g., 30) can include an outer surface that is textured, defines recesses and/or ridges, includes an adhesive, and/or the like, such that, for example, the mandrel physically resists (e.g., premature) separation and/or movement of wound section(s) of layer(s) of material (e.g., 18a, 18b, 18c, and/or the like) from and/or relative to the mandrel. A mandrel (e.g., 30) can be configured to be heated, which can facilitate bonding between adjacent sections of wound section(s) of layer(s) of material (e.g., 18a, 18b, 18c, and/or the like), and/or the like, and thus retention of the wound section(s) relative to the mandrel. In such embodiments, the mandrel can comprise a material having a relatively high thermal conductivity, such as, for example, silver, copper, aluminum, and/or the like. A mandrel (e.g., 30) can include an outer surface that defines one or more openings configured to be in fluid communication with a vacuum source (e.g., such that vacuum can be applied through the opening(s) to facilitate retention of wound section(s) of layer(s) of material (e.g., 18a, 18b, 18c, and/or the like) relative to the mandrel).

In some embodiments of the present methods, each layer of material (e.g., 18a, 18b, 18c, and/or the like) is disposed on a respective one of one or more pulleys (e.g., 38a, 38b, 38c, and/or the like), and the winding comprises rotating each pulley relative to a mandrel (e.g., 30) and about a longitudinal axis (e.g., 34) of the mandrel (though each pulley need not be rotated in the same direction). For example, in method 10a, at least a portion of layer of material 18a can be wound around pulley 38a—that can be characterized as a spool—and, as the pulley is rotated relative to mandrel 30 and about longitudinal axis 34 of the mandrel (e.g., generally in a direction indicated by arrow 42a), the layer of material can be wound around the mandrel as the layer of material is unwound from the pulley. As layer of material 18a is unwound from pulley 38a, the pulley can rotate about its longitudinal axis 46 (e.g., generally in a direction indicated by arrow 50). Such rotation of one or more pulleys (e.g., 38a, 38b, 38c, and/or the like) relative to a mandrel (e.g., 30) and about a longitudinal axis (e.g., 34) of the mandrel can be accomplished in any suitable fashion, including: (1) the mandrel being rotatably fixed about the longitudinal axis while the pulley(s) rotate about the longitudinal axis; (2) the pulley(s) being rotatably fixed about the longitudinal axis (ignoring any rotation of the pulley(s) about their respective longitudinal axe(s) 46) while the mandrel rotates about the longitudinal axis; or (3) the pulley(s) and the mandrel rotating about the longitudinal axis. At least one pulley (e.g., 38a, 38b, 38c, and/or the like) can be configured to tension a layer of material (e.g., 18a, 18b, 18c, and/or the like) that is at least partially disposed on the pulley as the layer of material is wound around a mandrel (e.g., 30), such as, for example, via a (e.g., frictional) resistance of the pulley to rotation about its longitudinal axis (e.g., 46), which can facilitate retention and/or placement of the wound section of the layer of material relative to the mandrel.

System 14a comprises a roller 54 configured to press layer(s) of material (e.g., 18a, 18b, 18c, and/or the like) that are wound around mandrel 30 against an outer surface of the mandrel. In at least this way, roller 54 can facilitate removal of air that may be trapped between wound section(s) of layer(s) of material (e.g., 18a, 18b, 18c, and/or the like) and mandrel 30, as well as retention and/or placement of the wound section(s) relative to the mandrel. A roller (e.g., 54) can be heated, which can provide for functions and advantages similar to those described above for heated mandrels. Roller 54 can comprise any one or more of the features described below with respect to roller 98.

Some embodiments of the present methods comprise translating a mandrel (e.g., 30) relative to one or more pulley(s) (e.g., 38a, 38b, 38c, and/or the like). For example, method 10a includes translating mandrel 30 relative to pulley 38a in a direction that is substantially aligned with longitudinal axis 34 of the mandrel (e.g., generally in a direction indicated by arrow 56). Such translation of a mandrel (e.g., 30) relative to one or more pulleys (e.g., 38a, 38b, 38c, and/or the like) can be accomplished in any suitable fashion, including: (1) the pulley(s) being translationally fixed, ignoring any rotation of the pulley(s) about a longitudinal axis (e.g., 34) of the mandrel or about their respective longitudinal ax(es) (e.g., 46), as the mandrel is translated; (2) the mandrel being translationally fixed as the pulley(s) are translated; or (3) via translation of both the pulley(s) and the mandrel.

Some embodiments of the present disclosure can be configured to produce a laminate in a continuous—as opposed to a batch—process, such that, for example, a length of the laminate may not be limited by a length of a mandrel (e.g., 30). For example, mandrel 30 can be characterized as an endless mandrel, including two or more mandrel segments (e.g., 30a and 30b) that are removably or movably coupled to one another. Mandrel segments (e.g., 30a and 30b) of a mandrel (e.g., 30) can be removably coupled to one another, such that, for example, after a mandrel segment has moved downstream of layer(s) of material (e.g., 18a, 18b, 18c, and/or the like) that are wound around the mandrel (e.g., downstream of cutter 110, described in more detail below), the mandrel segment can be decoupled from the mandrel and recoupled to the mandrel upstream of the wound section(s) (e.g., upstream of pulley(s) 38a, 38b, 38c, and/or the like) (e.g., a process generally illustrated by arrow 58).

Mandrel segments (e.g., 30a and 30b) can be movably coupled to one another (e.g., via a hinged or pivotal connection between adjacent ones of the mandrel segments), such that, for example, the mandrel segments can cooperate to define a continuous (e.g., loop) structure. In such embodiments, as a mandrel segment approaches a location that is both upstream of and proximate to layer(s) of material (e.g., 18a, 18b, 18c, and/or the like) that are wound around the mandrel (e.g., upstream of pulley(s) 38a, 38b, 38c, and/or the like), the mandrel segment can be pivoted or guided (e.g., via track(s), guide(s), roller(s), and/or the like) into proper alignment for receiving the layer(s) of material thereon (e.g., such that the mandrel segment is substantially aligned with another mandrel segment around which the layer(s) of material are wound). After the mandrel segment has moved downstream of the layer(s) of material (e.g., downstream of cutter 110), the mandrel segment can be pivoted or guided (e.g., via track(s), guide(s), roller(s), and/or the like) to ultimately return to the upstream location that is proximate to the layer(s) of material (e.g., in a continuous fashion).

Embodiments of the present disclosure can include or be configured for winding any suitable number of layer(s) of material (e.g., 18a, 18b, 18c, and/or the like) around a mandrel (e.g., 30) in any suitable fashion, such as, for example, to form wound section(s) having edge-to-edge and/or overlapping (e.g., each of which may be characterized as adjacent) sections. At least by varying these parameters, the present methods and systems can be configured to produce laminates having varying mechanical properties.

For example, method 10a includes winding a single layer of material 18a around mandrel 30 such that, for the wound section of the layer of material, each of a majority of fibers 22a is angularly disposed (e.g., at substantially a same angle 62a) relative to longitudinal axis 34 of the mandrel. In method 10a, layer of material 18a includes a first side edge 66a and a second side edge 66b, which is opposite the first side edge, and the winding is performed such that, for the wound section of the layer of material, the first side edge is beside or in an edge-to-edge relationship with (e.g., within 0.0 to 0.5 mm of) the second side edge (e.g., the first side edge is adjacent to the second side edge). Thus, method 10a and/or system 14a can be configured to produce an angle-ply laminate that, depending on how the wound section of layer of material 18a is slit to produce the laminate (described in more detail below), can have fibers 22a oriented at angle 62a relative to a long dimension of the laminate.

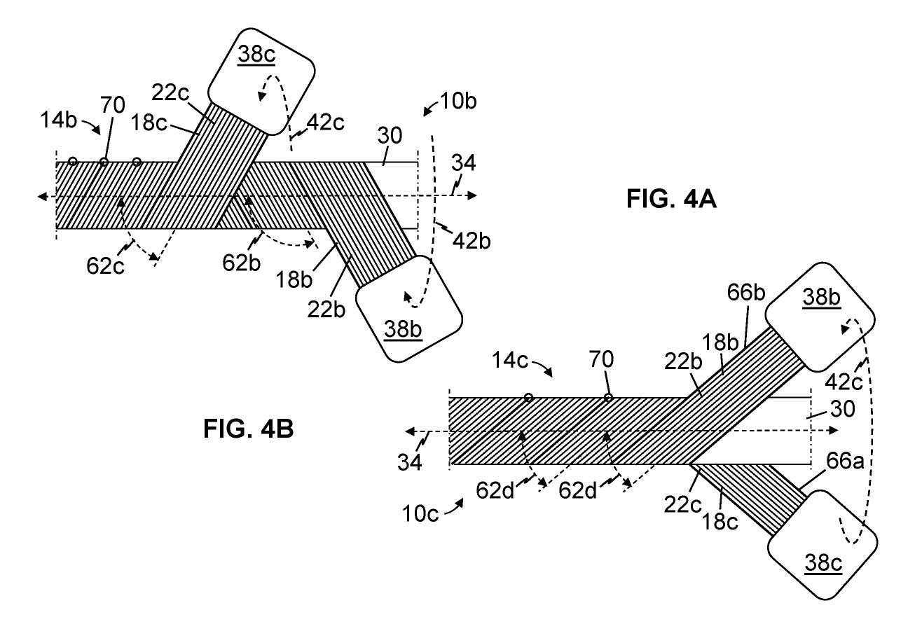

Referring additionally to FIG. 4A, shown is one embodiment 10b of the present methods as performed using one embodiment 14b of the present systems, each of which can be substantially similar to method 10a and system 14a, respectively, with the primary exceptions described below. Method 10b includes winding two layers of material, 18b and 18c, around mandrel 30 (e.g., step 204, FIG. 1). In method 10b and system 14b, layer of material 18b can be at least partially disposed on a pulley 38b, which can wind the layer of material around mandrel 30 as the pulley is rotated relative to the mandrel and about longitudinal axis 34 of the mandrel (e.g., generally in a direction indicated by arrow 42b). As shown, layer of material 18c can be at least partially disposed on a pulley 38c, which can wind the layer of material around mandrel 30 as the pulley is rotated relative to the mandrel and about longitudinal axis 34 of the mandrel (e.g., generally in a direction indicated by arrow 42c).

Similarly to method 10a, in method 10b, layers of material 18b and/or 18c can each be wound around mandrel 30 such that a first side edge 66a of the layer of material is beside a second side edge 66b of the layer of material. In method 10b, the winding can be performed such that the wound section of layer of material 18c overlies at least a portion of the wound section of layer of material 18b (e.g., such that wound sections of layers of material 18b and 18c are overlapping). As shown, the winding can be performed such that, for the wound section of layer of material 18b, each of a majority of fibers 22b is angularly disposed at substantially a first angle 62b relative to longitudinal axis 34 of mandrel 30, and, for the wound section of layer of material 18c, each of a majority of fibers 22c is angularly disposed at substantially a second angle 62c relative to the longitudinal axis of the mandrel. First angle 62b can differ from second angle 62c, such as, for example, by 10 to 80 degrees, 20 to 70 degrees, 30 to 60 degrees, 40 to 50 degrees, and/or the like. Thus, method 10b and system 14b can be configured to produce an angle-ply laminate that, depending on how the wound sections of layers of material 18b and 18c are slit to produce the laminate, can have fibers 22b oriented at angle 62b and fibers 22c oriented at angle 62c relative to a long dimension of the laminate.

Referring additionally to FIG. 4B, shown is one embodiment 10c of the present methods as performed using one embodiment 14c of the present systems, each of which can be substantially similar to method 10b and system 14b, respectively, with the primary exceptions described below. In method 10c and system 14c, pulleys 38b and 38c can each rotate relative to mandrel 30 and about longitudinal axis 34 of the mandrel in a same direction (e.g., generally in a direction indicated by arrow 42c) to wind layers of material 18b and 18c, respectively, around the mandrel. As shown, the winding can be performed such that: (1) a side edge (e.g., 66b) of layer of material 18b is beside a side edge (e.g., 66a) of layer of material 18c; and (2) for each layer of material, each of a majority of fibers, 22b and 22c, respectively, is angularly disposed (e.g., at substantially a same angle 62d) relative to longitudinal axis 34 of mandrel 30. Thus, method 10c and system 14c can be configured to produce an angle-ply laminate that, depending on how the wound sections of layers of material 18b and 18c are slit to produce the laminate, can have fibers 22b and 22c oriented at angle 62d relative to a long dimension of the laminate.

Some embodiments of the present methods include spot-joining adjacent sections of layer(s) of material (e.g., 18a, 18b, 18c, and/or the like) that are wound around a mandrel (e.g., 30) together (e.g., step 208, FIG. 1). Such spot-joining can include heating (e.g., using heated roller(s)), welding (e.g., infrared welding, laser welding, ultrasonic welding, friction welding, and/or the like), adhesive bonding, chemical bonding, and/or the like. For example, in method 10a, edge-to-edge sections of the wound section of layer of material 18a can be spot-joined together at joined spots 70. In method 10b, edge-to-edge sections of the wound section of layer of material 18b, edge-to-edge sections of the wound section of layer of material of material 18c, and/or overlapping sections of the wound sections of layers of material 18b and 18c can be spot-joined together at joined spots 70. In method 10c, edge-to-edge sections of the wound sections of layers of material 18b and 18c can be spot-joined together at joined spots 70. Such spot-joining may be performed such that at least two joined spots (e.g., 70) lie along a line (e.g., 74) that is substantially parallel to a longitudinal axis (e.g., 34) of a mandrel (e.g., 30) (FIG. 2A). In these ways and others, some embodiments of the present disclosure can facilitate locating layer(s) of material (e.g., 18a, 18b, 18c, and/or the like) relative to one another along a mandrel (e.g., 30), while mitigating imperfections, such as distortions of the layer(s) of material, in a produced laminate. In some embodiments, adjacent sections of layer(s) of material (e.g., 18a, 18b, 18c, and/or the like) that are wound around a mandrel (e.g., 30) can be joined via continuous welding (e.g., along side edge(s) of the layer(s) of material, along a longitudinal axis 34 of the mandrel, and/or the like).

Such spot-joining can be performed using any suitable structure(s), and the following description of system 14a is provided only by way of example. System 14a comprises a welder 78 (e.g., an infrared welder, laser welder, ultrasonic welder, friction welder, and/or the like) configured to spot weld adjacent sections of layer(s) of material (e.g., 18a, 18b, 18c, and/or the like) that are wound around mandrel 30. Welder 78 is rotatably fixed about longitudinal axis 34 of mandrel 30; in other embodiments, a welder (e.g., 78) can be configured to rotate relative to a longitudinal axis (e.g., 34) of a mandrel (e.g., 30), such as, for example, with at least one of one or more pulleys (e.g., 38a, 38b, 38c, and/or the like), with the mandrel, and/or the like. Welder 78 is configured to translate relative to mandrel 30 (e.g., in a direction that is substantially aligned with longitudinal axis 34 of the mandrel). Such translation of a welder (e.g., 78) relative to a mandrel (e.g., 30) can be accomplished in any suitable fashion, including: (1) the welder being translationally fixed, ignoring any rotation of the welder about a longitudinal axis (e.g., 34) of the mandrel, as the mandrel is translated; (2) the mandrel being translationally fixed as the welder is translated (e.g., via movement of a carriage to which the welder can be coupled and/or the like); or (3) via translation of both the welder and the mandrel.

A welder (e.g., 78) can be configured to periodically produce spot welds based on, for example, (e.g., sensor based) detection of a side edge (e.g., 66a or 66b) of at least one of one or more layers of material (e.g., 18a, 18b, 18c, and/or the like), a rotational position and/or speed of at least one of one or more pulleys (e.g., 38a, 38b, 38c, and/or the like) relative to a mandrel (e.g., 30), a width of at least one of the layer(s) of material, an angle between a long dimension of at least one of the layer(s) of material and a longitudinal axis (e.g., 34) of the mandrel (e.g., a winding angle of the layer of material), and/or the like. A welder (e.g., 78) can include multiple welding tips or heads, such that, for example, the welder can produce two or more spot welds in a simultaneous or substantially simultaneous fashion.

Some embodiments of the present methods comprise disposing a tape (e.g., 82) over layer(s) of material (e.g., 18a, 18b, 18c, and/or the like) that are wound around a mandrel (e.g., 30) such that at least a portion (e.g., 86) of the tape overlies at least a portion of the wound section of each layer of material (but does not necessarily contact the wound section of each layer of material) (e.g., step 212, FIG. 1). Such tapes (e.g., 82) can include any suitable material, such as, for example, a thermoplastic material, which can be selected to match a matrix material (e.g., 26) of layer(s) of material (e.g., 18a, 18b, 18c, and/or the like) over which the tape is to be disposed, and may or may not comprise fibers. In method 10a, tape 82 is disposed over layer of material 18a such that at least a portion 86 of the tape overlies the wound section of the layer of material, and more particularly, at least two edge-to-edge sections thereof. Portion 86 of tape 82 includes a long dimension, which can be substantially parallel to longitudinal axis 34 of mandrel 30, and a width 90 (e.g., half of the width is depicted in FIG. 2A), which can be smaller than outer perimeter 36 of the mandrel (e.g., less than one half of the outer perimeter of the mandrel).

Some embodiments of the present methods comprise bonding a portion (e.g., 86) of a tape (e.g., 82) to layer(s) of material (e.g., 18a, 18b, 18c, and/or the like) that are wound around a mandrel (e.g., 30). Such bonding can include heating (e.g., using heated roller(s)), welding (e.g., infrared welding, laser welding, ultrasonic welding, friction welding, and/or the like), adhesive bonding, chemical bonding, and/or the like. In these ways and others, some embodiments of the present disclosure can facilitate locating layer(s) of material (e.g., 18a, 18b, 18c, and/or the like) relative to one another along a mandrel (e.g., 30), while mitigating imperfections, such as distortions of the layer(s) of material, in a produced laminate.

Such disposing and/or bonding of a tape (e.g., 82), or a portion (e.g., 86) thereof, over and/or to wound section(s) of layer(s) of material (e.g., 18a, 18b, 18c, and/or the like) can be performed using any suitable structure(s), and the following description of system 14a is provided only by way of example. System 14a includes a tape dispenser 94 that can include a spool around which a tape (e.g., 82) can be wound and from which at least a portion (e.g., 86) of the tape can be provided to layer(s) of material (e.g., 18a, 18b, 18c, and/or the like) that are wound around mandrel 30. Similarly to as described above for a welder (e.g., 78), such a tape dispenser (e.g., 94) may or may not be configured to rotate relative to a longitudinal axis (e.g., 34) of a mandrel (e.g., 30) and may or may not be configured to translate relative to the mandrel.

System 14a includes a roller 98 configured to press a tape (e.g., 82), or a portion (e.g., 86) thereof, against wound section(s) of layer(s) of material (e.g., 18a, 18b, 18c, and/or the like). Such a roller (e.g., 98) can facilitate bonding of a tape (e.g., 82), or a portion (e.g., 86) thereof, to layer(s) of material (e.g., 18a, 18b, 18c, and/or the like) that are wound around a mandrel (e.g., 30) and/or removal of any air that may be trapped between the tape, or portion thereof, and the layer(s) of material.

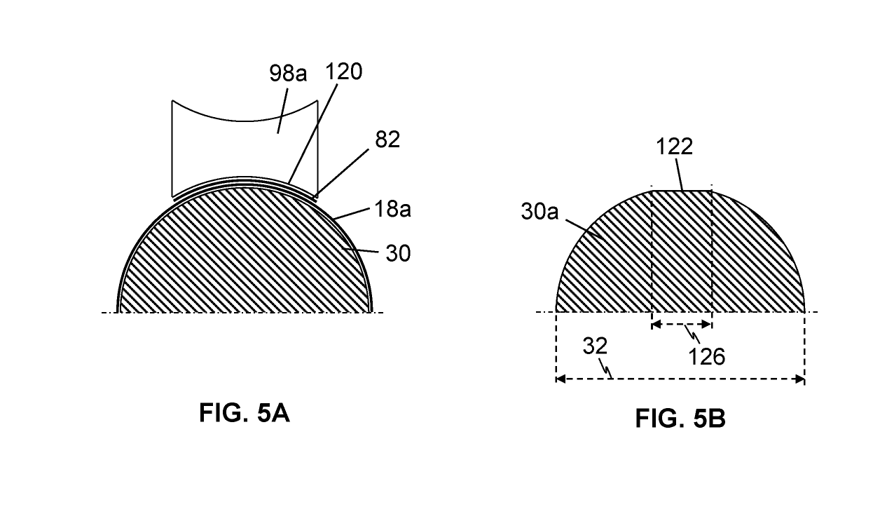

Provided by way of example, FIG. 5A depicts a roller 98a that may be suitable for use in some embodiments (e.g., 14a, as roller 98) of the present disclosure. Roller 98a can have a shape that corresponds to a shape of mandrel 30. For example, a portion of roller 98a and a portion of mandrel 30 that contact one another can each have a surface, where the surfaces have substantially similar curvatures, a cross-section of the portion of the roller and a cross-section of the portion of the mandrel can have substantially the same shape (e.g., both being circular and having substantially the same radius, as shown in FIG. 5A), and/or the like. For further example, roller 98 can define a groove 120 configured to receive a portion of mandrel 30. In at least these ways, an area of contact between roller 98a and mandrel 30 can be increased.

A roller (e.g., 98) can comprise a resilient material, such that, for example, an area of contact between the roller and a mandrel (e.g., 30) increases with force applied by the roller to the mandrel. Such a resilient material can include, for example, rubber, an elastomer, polyurethane, a resilient thermoplastic material, and/or the like. A roller (e.g., 98) can be heated, which can provide for functions and advantages similar to those described above for heated mandrels.

Referring additionally to FIG. 5B, shown is a mandrel 30a that may be suitable for use in some embodiments (e.g., 14a, as mandrel 30) of the present disclosure. Mandrel 30a can be configured to facilitate bonding of a tape (e.g., 82) to layer(s) of material (e.g., 18a, 18b, 18c, and/or the like) that are wound around the mandrel and/or removal of any air that may be trapped between the tape and the layer(s) of material. For example, mandrel 30a can include a planar portion 122 that can extend along longitudinal axis 34 of the mandrel. Planar portion 122 can have a width 126 that is substantially equal to a width of a tape (e.g., 82) and/or roller 98, that is greater than or equal to any one of, or between any two of: 5, 10, 15, 20, 25, 30, 35, or more % of a maximum transverse dimension (e.g., 32) of the mandrel, and/or the like. Such a planar portion (e.g., 122) of a mandrel (e.g., 30a) can increase an area of contact between a roller (e.g., 98) and the mandrel, facilitate placement of a tape (e.g., 82) relative to the mandrel, and/or guide component(s) (e.g., roller 54, welder 78, tape dispenser 94, roller 98, laser 102, cutter 110, roller 118, and/or the like) during movement of the component(s) relative to the mandrel (e.g., by providing a flat surface along which the component(s) can move relative to the mandrel).

System 14a includes a laser 102 configured to weld a tape (e.g., 82), or a portion (e.g., 86) thereof, to layer(s) of material (e.g., 18a, 18b, 18c, and/or the like) that are wound around a mandrel (e.g., 30), by, for example, directing one or more laser beams to a portion of the tape proximate to and downstream of roller 98. In some embodiments, bonding of a tape (e.g., 82) to layer(s) of material (e.g., 18a, 18b, 18c, and/or the like) that are wound around a mandrel (e.g., 30) can be performed using an infrared welder, an ultrasonic welder, a friction welder, one or more heated rollers (e.g., 98), and/or the like (e.g., with or without use of a laser 102).

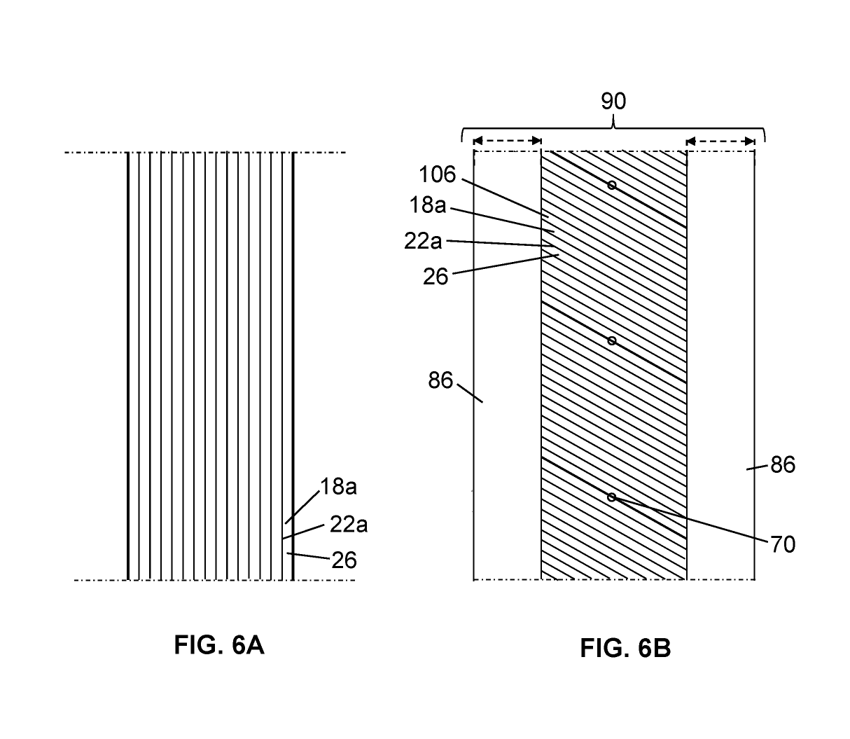

Referring additionally to FIGS. 6A and 6B, some embodiments of the present methods include slitting at least a portion of layer(s) of material (e.g., 18a, 18b, 18c, and/or the like) that are wound around a mandrel (e.g., 30) to produce a laminate (e.g., step 216, FIG. 1). In method 10a, the wound section of layer of material 18a can be slit and removed from mandrel 30 to produce laminate 106. As shown, the slitting is performed along a line that is substantially parallel to longitudinal axis 34 of mandrel 30. In embodiments where a tape (e.g., 82), or a portion (e.g., 86) thereof, is disposed over wound section(s) of layer(s) of material (e.g., 18a, 18b, 18c, and/or the like), the slitting can include slitting the tape, or portion thereof. In method 10a, the slitting is performed such that portion 86 of tape 82 is substantially bisected. As shown in FIG. 6B, after slitting, portion 86 of tape 82 is disposed on opposing side edges of laminate 106. In these ways and others, some embodiments of the present disclosure can protect layer(s) of material (e.g., 18a, 18b, 18c, and/or the like) that are wound around a mandrel (e.g., 30) from damage that might otherwise occur during or after slitting of the wound section(s) of the layer(s) of material to produce a laminate.

Such slitting of layer(s) of material (e.g., 18a, 18b, 18c, and/or the like) that are wound around a mandrel (e.g., 30) can be performed using any suitable structure(s), and the following description of system 14a is provided only by way of example. System 14a comprises a cutter 110 that can include a blade or edge configured to cut wound section(s) of layer(s) of material (e.g., 18a, 18b, 18c, and/or the like) to produce a laminate (e.g., 106). Similarly to as described above for a welder (e.g., 78), such a cutter (e.g., 110) may or may not be configured to rotate relative to a longitudinal axis (e.g., 34) of a mandrel (e.g., 30) and may or may not be configured to translate relative to the mandrel. In some embodiments, a cutter (e.g., 110) can comprise a laser. System 14a includes a spool 114, around which a laminate (e.g., 106) can be wound once wound section(s) of layer(s) of material (e.g., 18a, 18b, 18c, and/or the like) are slit to produce the laminate, which can be facilitated by one or more rollers 118.

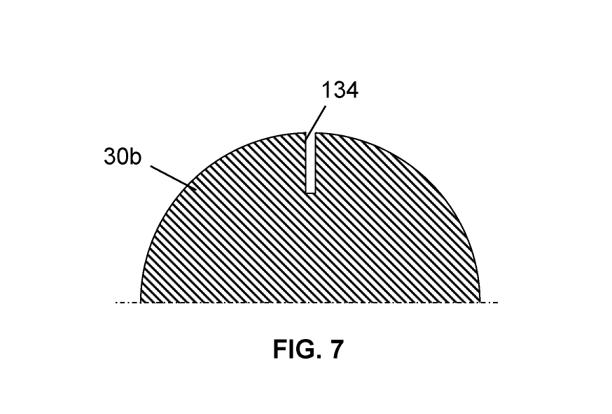

Referring additionally to FIG. 7, shown is a mandrel 30b that may be suitable for use in some embodiments (e.g., 14a, as mandrel 30) of the present disclosure. Mandrel 30b can include a groove 134 configured to receive the blade or edge of cutter 110 in order to guide the blade or edge along the mandrel during cutting of layer(s) of material (e.g., 18a, 18b, 18c, and/or the like) that are wound around the mandrel. Groove 134 can be substantially aligned with longitudinal axis 34 of mandrel 30b. Groove 134 can facilitate accurate and/or straight cutting by the blade or edge of cutter 110, mitigate gouging of a surface of mandrel 30b with the blade or edge, and/or the like.

Component(s) (e.g., roller 54, welder 78, tape dispenser 94, roller 98, laser 102, cutter 110, roller 118, and/or the like) of the present systems (e.g., 14a) can be disposed on one or more carriages (e.g., 130, FIG. 2A) that are movable relative to a mandrel (e.g., 30). Such carriage(s) (e.g., 130) can facilitate movement of one or more of the component(s) relative to a mandrel (e.g., 30) in unison, placement of two or more of the component(s) relative to one another, and/or the like.

Some embodiments of the present methods for producing a laminate comprise: winding a section of each of one or more layers of material around a mandrel and about a longitudinal axis of the mandrel, wherein each layer of material includes fibers and the winding is performed such that, for the wound section of each layer of material, each of a majority of the fibers is angularly disposed relative to the longitudinal axis of the mandrel. In some embodiments, the fibers of at least one of the layer(s) of material comprises carbon fibers. In some embodiments, the fibers of at least one of the layer(s) of material comprises glass fibers. In some embodiments, the fibers of at least one of the layer(s) of material comprises basalt fibers. In some embodiments, at least one of the layers of material includes a matrix material. In some embodiments, the matrix material comprises a thermoplastic material. In some embodiments, at least one of the layer(s) of material comprises unidirectional fiber tape.

In some embodiments, the one or more layers of material includes two or more layers of material. In some embodiments, the winding is performed such that the wound section of at least one of the layers of material overlies the wound section of at least one other of the layers of material. In some embodiments, the winding is performed such that a side edge of at least one of the layers of material is beside a side edge of at least one other of the layers of material.

In some embodiments, the winding is performed such that for the wound section of a first one of the layers of material, each of a majority of the fibers is angularly disposed at substantially a first angle relative to the longitudinal axis of the mandrel and for the wound section of a second one of the layers of material, each of a majority of the fibers is angularly disposed at substantially a second angle relative to the longitudinal axis of the mandrel, wherein the first angle differs from the second angle. In some embodiments, the first angle differs from the second angle by 10 to 80 degrees. In some embodiments, the first angle differs from the second angle by 20 to 70 degrees. In some embodiments, the first angle differs from the second angle by 30 to 60 degrees. In some embodiments, the first angle differs from the second angle by 40 to 50 degrees.

In some embodiments, each of the layer(s) of material is disposed on a respective one of one or more pulleys and the winding comprises rotating each pulley relative to the mandrel and about the longitudinal axis of the mandrel. Some embodiments comprise translating the mandrel relative to the pulley(s) in a direction that is substantially aligned with the longitudinal axis of the mandrel. In some embodiments, the mandrel comprises an endless mandrel having two or more mandrel segments that are removably or movably coupled to one another.

Some embodiments comprise spot-joining adjacent sections of the wound section(s) together. In some embodiments, the one or more layers of material comprises a first layer of material and a second layer of material, the winding is performed such that the wound section of the second layer of material overlies the wound section of the first layer of material, and the spot-joining is performed such that the first layer of material is spot-joined to the second layer of material. In some embodiments, the one or more layers of material comprises a first layer of material and a second layer of material, the winding is performed such that a side edge of the first layer of material is beside a side edge of the second layer of material, and the spot-joining is performed such that the first layer of material is spot-joined to the second layer of material.

In some embodiments, the spot-joining is performed such that at least two of the joined spots lie along a line that is substantially parallel to the longitudinal axis of the mandrel. In some embodiments, the spot-joining comprises applying heat to the adjacent sections of the wound section(s). In some embodiments, the spot-joining comprises spot welding. In some embodiments, the spot welding comprises at least one of the group consisting of: infrared welding, laser welding, ultrasonic welding, and friction welding.

Some embodiments comprise disposing a tape over the layer(s) of material such that at least a portion of the tape overlies at least a portion of the wound section of each layer of material. In some embodiments, the disposing is performed such that a long dimension of the portion of the tape is substantially parallel to the longitudinal axis of the mandrel. In some embodiments, the portion of the tape has a width that is smaller than an outer perimeter of the mandrel, the outer perimeter being taken in a plane that is perpendicular to the longitudinal axis of the mandrel. In some embodiments, the width of the portion of the tape is less than half of the outer perimeter of the mandrel.

Some embodiments comprise bonding the tape to the wound section of at least one of the layer(s) of material. In some embodiments, the bonding comprises applying heat to the tape. In some embodiments, the bonding comprises welding. In some embodiments, the welding comprises at least one of the group consisting of: infrared welding, laser welding, ultrasonic welding, and friction welding. In some embodiments, the bonding is performed, at least in part, by moving a roller relative to the mandrel in a direction that is substantially aligned with the longitudinal axis of the mandrel, the tape being disposed between the roller and the mandrel. In some embodiments, during the bonding, a portion of the mandrel is disposed within a groove of the roller. In some embodiments, the mandrel defines a planar portion extending along the longitudinal axis of the mandrel, and, during the bonding, the tape is disposed between the roller and the planar portion of the mandrel.

Some embodiments comprise slitting at least a portion of each of the wound section(s) to produce the laminate. In some embodiments, the slitting is performed along a line that is substantially parallel to the longitudinal axis of the mandrel. Some embodiments comprise slitting the portion of the tape to produce the laminate. In some embodiments, the slitting is performed such that the portion of the tape is disposed on opposing side edges of the laminate. In some embodiments, the slitting is performed such that the portion of the tape is substantially bisected. In some embodiments, the mandrel defines a groove extending along the longitudinal axis of the mandrel, and the slitting is performed, at least in part, by moving a blade or edge of a cutter relative to the mandrel within and along the groove.

Some embodiments of the present systems for producing a laminate comprise: a mandrel having a longitudinal axis, one or more pulleys, each configured to receive a respective one of one or more layers of material and rotate relative to the mandrel and about the longitudinal axis of the mandrel to wind a section of a respective layer of material around the mandrel.

Some embodiments comprise a tape dispenser configured to dispose a tape over the layer(s) of material such that at least a portion of the tape overlies at least a portion of the wound section of each layer of material and a long dimension of the portion of the tape is substantially parallel to the longitudinal axis of the mandrel.

Some embodiments comprise a welder configured to spot weld adjacent sections of the wound section(s) together. In some embodiments, the welder is configured to form spot welds lying along a line that is substantially parallel to the longitudinal axis of the mandrel.

Some embodiments comprise a cutter configured to slit at least a portion of the wound section of each layer of material along a line that is substantially parallel to the longitudinal axis of the mandrel.

### EXAMPLES

The present invention will be described in greater detail by way of specific examples. The following examples are offered for illustrative purposes only and are not intended to limit the invention in any manner. Those of skill in the art will readily recognize a variety of noncritical parameters that can be changed or modified to yield essentially the same results.

### Example 1

### Angle-Ply Laminates Produced from Unidirectional Fiber Tapes

To produce each of the angle-ply laminates (Samples 1-6) listed in Table 1, one or more unidirectional fiber tapes were consecutively wound around a cylindrical mandrel such that, for each tape, adjacent wraps of the tape were in an edge-to-edge relationship and the tape formed a ply of the laminate. During winding of each tape, the tape was tensioned at approximately 1 newton (N) per mm width of the tape. To secure the tape(s) relative to the mandrel, adjacent wraps of each tape were spot welded together at each end of the mandrel. Once wound around the mandrel, the tape(s) were cut along the length of the mandrel, and the laminate was removed from the mandrel. Each of the resulting laminates had satisfactory properties.

TABLE 1
Angle-Ply Laminates Produced from Unidirectional Fiber Tapes

| | Width of | Winding Angle | | | | | |
|---|---|---|---|---|---|---|---|
| Sample | each Tape | Tape | | Tape | Tape | | |
| # | (mm) | 1 | Tape 2 | 3 | 4 | Tape 5 | Tape 6 |
| 1 | 12 | 60° | | | | | |
| 2 | 12 | 90° | 60° | | | | |
| 3 | 50 | 45° | −45° | | | | |
| 4 | 50 | 45° | −45° | | | | |
| 5 | 50 | 45° | 45° (half | | | | |
| | | | overlap) | | | | |
| 6 | 50 | 90° | 60° | 45° | −45° | −60° | 90° |

### Example 2

### Scrap Estimates

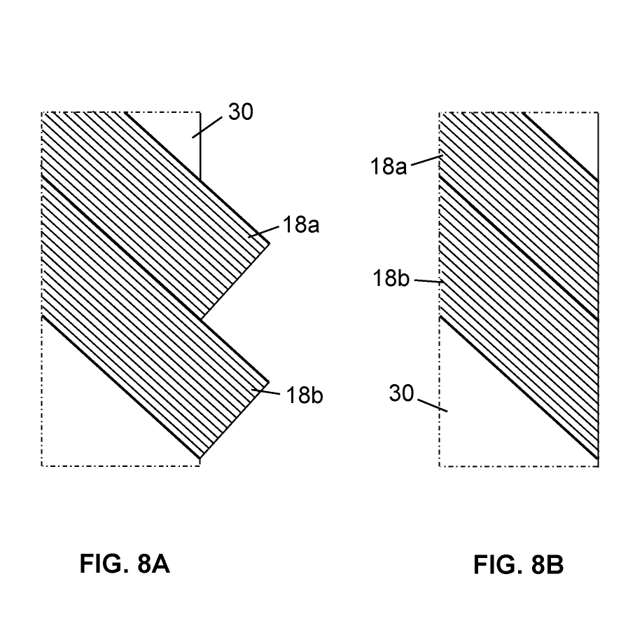

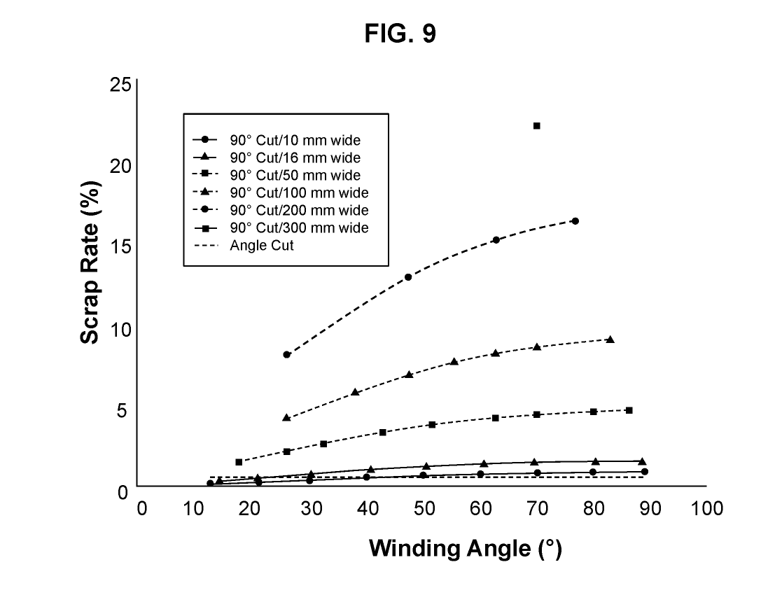

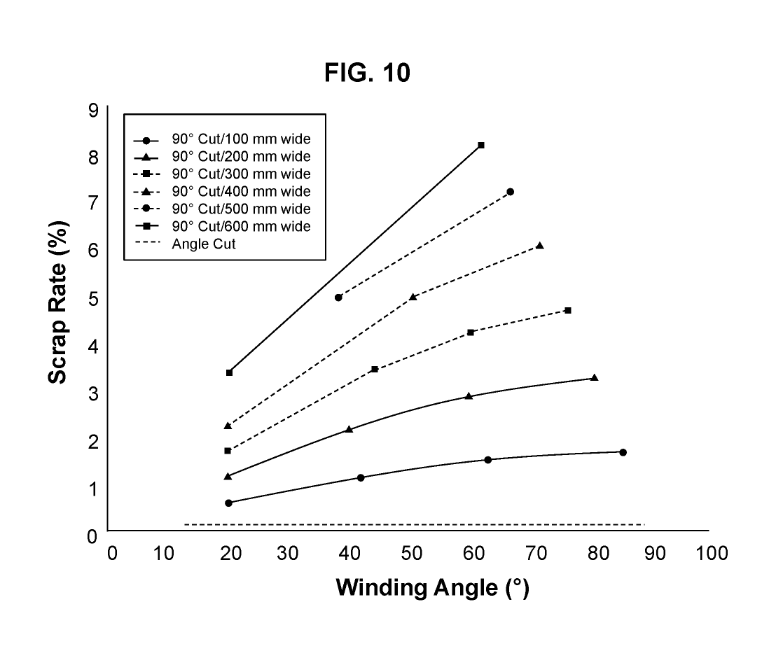

Scrap estimates were prepared considering two methods of cutting the layer(s) of material to form the ends of the layer(s): (1) cutting each of the layer(s) at 90° relative to a length of the layer (FIG. 8A; “90° cut” layers); and (2) cutting each of the layer(s) such that the ends of the layer(s) are flush with the ends of the mandrel when the layer(s) are wound around the mandrel (FIG. 8B; “angle cut” layers). FIGS. 9 and 10 depict such scrap estimates using a mandrel having a 284 mm diameter and a 406 mm diameter, respectively, and layers of material having various widths and wound around the mandrel at various winding angles. As shown, scrap rate can generally be reduced by reducing a winding angle at which a given layer of material is wound around a mandrel and/or by using angle cut layers, layers having smaller widths, and/or mandrels having larger diameters.

### Example 3

### Production Speed Estimates

Production speed estimates for producing laminates using embodiments of the present disclosure were prepared. Steps considered included, for each layer of material: (1) securing an end of the layer at a first end of the mandrel by spot-welding adjacent wraps of the layer together at the first end of the mandrel (“Weld”); (2) winding the layer around the mandrel (“Wind”); (3) securing the layer at a second end of the mandrel by spot-welding adjacent wraps of the layer together at the second end of the mandrel and cutting the layer to form an end of the layer (“Weld/Cut”); and (4) returning to the first end of the mandrel (“Return”), and, after performing steps (1)-(4) for each layer, (5) securing adjacent sections of the layer(s) relative to one another along the mandrel (e.g., by spot-welding, disposing a tape over the layer(s) of material, and/or the like) and cutting the layer(s) of material in order to remove the laminate from the mandrel (“Final Weld/Cut”).

Such production speed estimates for producing a 12 ply laminate using a mandrel having a diameter of 284 mm and a length of 1000 mm are shown in Table 2.

TABLE 2
Production Speed Estimates for Producing a 12 Ply Laminate using a
Mandrel having a Diameter of 284 mm and a Length of 1000 mm

| | | | Increased Winding | | Increased Welding | | | |
|---|---|---|---|---|---|---|---|---|
| | Baseline | | Speed | | Speed | | Two-way Winding | |
| | Time | Time | Time | Time | Time | Time | Time | Time |
| | (One Ply) | (All Plies) | (One Ply) | (All Plies) | (One Ply) | (All Plies) | (One Ply) | (All Plies) |
| Step | (s) | (s) | (s) | (s) | (s) | (s) | (s) | (s) |
| Weld | 22 | 264 | 22 | 264 | 4 | 48 | 4 | 48 |
| Wind | 38 | 456 | 9 | 108 | 9 | 108 | 9 | 108 |
| Weld/Cut | 39 | 468 | 39 | 468 | 5 | 60 | 5 | 60 |
| Return | 13 | 156 | 8 | 96 | 8 | 96 | 0 | 0 |
| Final | | 300 | | 300 | | 60 | | 60 |
| Weld/Cut | | | | | | | | |
| Total Time | | 1644 | | 1236 | | 372 | | 276 |
| (s) | | | | | | | | |
| Production | | 0.033 | | 0.043 | | 0.144 | | 0.194 |
| Speed | | | | | | | | |
| (m²/min) | | | | | | | | |

As shown, significant increases in production speed can be achieved by increasing the speed at which the layer(s) of material are wound around the mandrel, the speed at which the layer(s) of material are welded, and by using two-way winding (winding layers of material around the mandrel starting at the first end of the mandrel and winding layers of material around the mandrel starting at the second end of the mandrel, thereby eliminating the Return step).

Production speed estimates for producing 12, 3, 2, and 1 ply laminates using a mandrel having a diameter of 284 mm and a length of 1000 mm and two-way winding are shown in Table 3.

TABLE 3
Production Speed Estimates for Producing 12, 3, 2, and 1 Ply Laminates
using a Mandrel having a Diameter of 284 mm and a Length of 1000 mm and Two-way
Winding

| | 12 Plies | | 3 Plies | | 2 Plies | | 1 Ply | |
|---|---|---|---|---|---|---|---|---|
| | | Time | | Time | | Time | | Time |
| | Time | (All | Time | (All | Time | (All | Time | (All |
| | (One Ply) | Plies) | (One Ply) | Plies) | (One Ply) | Plies) | (One Ply) | Plies) |
| Step | (s) | (s) | (s) | (s) | (s) | (s) | (s) | (s) |
| Weld | 4 | 48 | 4.5 | 13.5 | 5 | 10 | 6 | 6 |
| Wind | 9 | 108 | 9 | 27 | 9 | 18 | 9 | 9 |
| Weld/Cut | 5 | 60 | 5.5 | 16.5 | 6 | 12 | 7 | 7 |
| Return | 0 | 0 | 0 | 0 | 0 | 0 | 0 | 0 |
| Final | | 60 | | 60 | | 60 | | 60 |
| Weld/Cut | | | | | | | | |
| Total Time | | 276 | | 117 | | 100 | | 82 |
| (s) | | | | | | | | |
| Production | | 0.194 | | 0.458 | | 0.535 | | 0.653 |
| Speed | | | | | | | | |
| (m²/min) | | | | | | | | |

Production speed estimates for producing 1 and 3 ply laminates using mandrels having diameters of 406 mm and lengths of 1000 mm and 6000 mm and two-way winding are shown in Table 4.

TABLE 4
Production Speed Estimates for Producing 1 and 3 Ply Laminates using
Mandrels having Diameters of 406 mm and Lengths of 1000 mm and 6000 mm and
Two-way Winding

| | Mandrel Length of | | Mandrel Length of | | Mandrel Length of | | Mandrel Length of | |
|---|---|---|---|---|---|---|---|---|
| | 1000 mm; 3 Plies | | 1000 mm; 1 Ply | | 6000 mm; 3 Plies | | 6000 mm; 1 Ply | |
| | | Time | | Time | | Time | | Time |
| | Time | (All | Time | (All | Time | (All | Time | (All |
| | (One Ply) | Plies) | (One Ply) | Plies) | (One Ply) | Plies) | (One Ply) | Plies) |
| Step | (s) | (s) | (s) | (s) | (s) | (s) | (s) | (s) |
| Weld | 6 | 13.5 | 6 | 6 | 6 | 18 | 6 | 6 |
| Wind | 9 | 27 | 9 | 9 | 54 | 162 | 54 | 54 |
| Weld/Cut | 7 | 16.5 | 7 | 7 | 7 | 21 | 7 | 7 |
| Return | 0 | 0 | 0 | 0 | 0 | 0 | 0 | 0 |
| Final | 0 | 60 | | 60 | | 360 | | 360 |
| Weld/Cut | | | | | | | | |
| Total Time | | 117 | | 82 | | 561 | | 427 |
| (s) | | | | | | | | |
| Production | | 0.654 | | 0.933 | | 0.818 | | 1.075 |
| Speed | | | | | | | | |
| (m²/min) | | | | | | | | |

### Example 4

### Relationship Between Layer Width, Mandrel Diameter, and Winding Angle

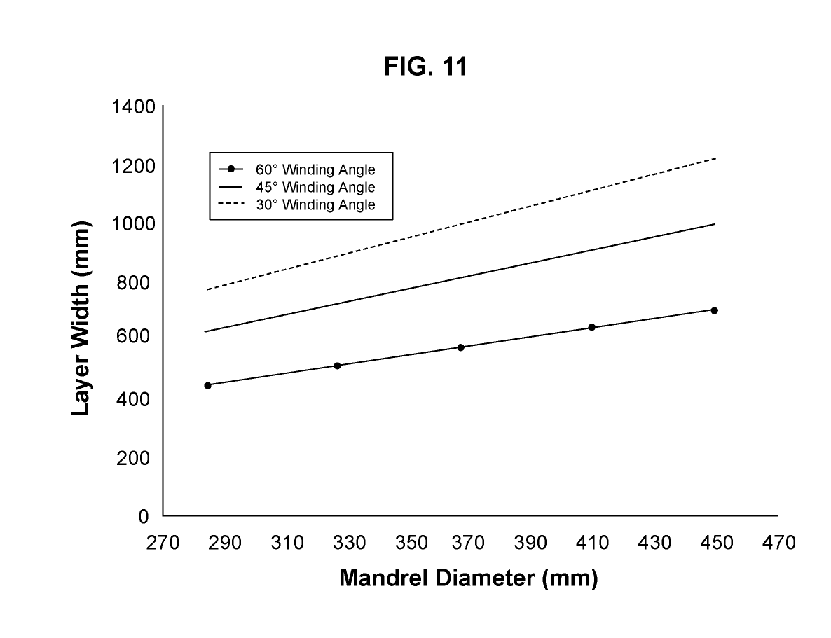

FIG. 11 is a graph illustrating the width of a layer of material that is desirable (e.g., to avoid deformation of the layer) when the layer is to be wound around a mandrel such that adjacent wraps of the layer of material are in an edge-to-edge relationship for various mandrel diameters and winding angles. As shown, a wider layer is generally desirable when winding the layer around a mandrel at a smaller winding angle and/or when the mandrel has a larger diameter.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown can include some or all of the features of the depicted embodiment. For example, elements can be omitted or combined as a unitary structure, and/or connections can be substituted. Further, where appropriate, aspects of any of the examples described above can be combined with aspects of any of the other examples described to form further examples having comparable or different properties and/or functions, and addressing the same or different problems. Similarly, it will be understood that the benefits and advantages described above can relate to one embodiment or can relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A method for producing a laminate, the method comprising:
winding a section of each of one or more layers of material around a mandrel and about a longitudinal axis of the mandrel, wherein:
each layer of material includes fibers; and
the winding is performed such that, for the wound section of each layer of material, each of a majority of the fibers is angularly disposed relative to the longitudinal axis of the mandrel; and
spot-joining adjacent sections of the wound section(s) together.

2. The method of claim 1, comprising disposing a tape over the layer(s) of material such that at least a portion of the tape overlies at least a portion of the wound section of each layer of material.

3. The method of claim 2, wherein the disposing is performed such that a long dimension of the portion of the tape is substantially parallel to the longitudinal axis of the mandrel.

4. A method for producing a laminate, the method comprising:
winding a section of each of one or more layers of material around a mandrel and about a longitudinal axis of the mandrel, wherein:
each layer of material includes fibers; and
the winding is performed such that, for the wound section of each layer of material, each of a majority of the fibers is angularly disposed relative to the longitudinal axis of the mandrel; and
disposing a tape over the layer(s) of material such that:
at least a portion of the tape overlies at least a portion of the wound section of each layer of material; and
a long dimension of the portion of the tape is substantially parallel to the longitudinal axis of the mandrel.

5. The method of claim 4, comprising spot-joining adjacent sections of the wound section(s) together.

6. The method of any of claim 1-3 or 5, wherein:
the one or more layers of material comprises a first layer of material and a second layer of material;
the winding is performed such that the wound section of the second layer of material overlies the wound section of the first layer of material; and
the spot-joining is performed such that the first layer of material is spot-joined to the second layer of material.

7. The method of any of claim 1-3 or 5, wherein:
the one or more layers of material comprises a first layer of material and a second layer of material;
the winding is performed such that a side edge of the first layer of material is beside a side edge of the second layer of material; and
the spot-joining is performed such that the first layer of material is spot-joined to the second layer of material.

8. The method of any of claim 1-3 or 5, wherein the spot-joining is performed such that at least two of the joined spots lie along a line that is substantially parallel to the longitudinal axis of the mandrel.

9. The method of any of claims 2-5, wherein:
the portion of the tape has a width that is smaller than an outer perimeter of the mandrel, the outer perimeter being taken in a plane that is perpendicular to the longitudinal axis of the mandrel; and
wherein, optionally, the width of the portion of the tape is less than half of the outer perimeter of the mandrel.

10. The method of any of claims 2-5, comprising slitting the portion of the tape to produce the laminate.

11. The method of claim 10, wherein the slitting is performed along a line that is substantially parallel to the longitudinal axis of the mandrel.

12. The method of claim 10, wherein:
the mandrel defines a groove extending along the longitudinal axis of the mandrel; and
the slitting is performed, at least in part, by moving a blade or edge of a cutter relative to the mandrel within and along the groove.

13. The method of any of claims 2-5, comprising bonding the tape to the wound section of at least one of the layer(s) of material.

14. The method of claim 13, wherein:
the bonding is performed, at least in part, by moving a roller relative to the mandrel in a direction that is substantially aligned with the longitudinal axis of the mandrel, the tape being disposed between the roller and the mandrel;
optionally, during the bonding, a portion of the mandrel is disposed within a groove of the roller; and
optionally:
the mandrel defines a planar portion extending along the longitudinal axis of the mandrel; and
during the bonding, the tape is disposed between the roller and the planar portion of the mandrel.

15. The method of any of any of claims 1-5, wherein:
the one or more layers of material includes two or more layers of material; and
the winding is performed such that the wound section of at least one of the layers of material overlies the wound section of at least one other of the layers of material.

16. The method of any of claims 1-5, wherein:
the one or more layers of material includes two or more layers of material; and
the winding is performed such that a side edge of at least one of the layers of material is beside a side edge of at least one other of the layers of material.

17. A system for producing a laminate, the system comprising:
a mandrel having a longitudinal axis;
one or more pulleys, each configured to:
receive a respective one of one or more layers of material; and
rotate relative to the mandrel and about the longitudinal axis of the mandrel to wind a section of the respective layer of material around the mandrel; and
a tape dispenser configured to dispose a tape over the layer(s) of material such that:
at least a portion of the tape overlies at least a portion of the wound section of each layer of material; and
a long dimension of the portion of the tape is substantially parallel to the longitudinal axis of the mandrel.

18. The system of claim 17, comprising a welder configured to spot weld adjacent sections of the wound section(s) together.

19. The system of claim 18, wherein the welder is configured to form spot welds lying along a line that is substantially parallel to the longitudinal axis of the mandrel.

20. The system of any of claims 17-19, comprising a cutter configured to slit at least a portion of the wound section of each layer of material along a line that is substantially parallel to the longitudinal axis of the mandrel.
